(19) United States
(12) Patent Application Publication
(10) Pub. No.: US 2005/0154700 A1
(43) Pub. Date: Jul. 14, 2005

(54) System and method of costs saving procedure automation and result optimization in looping industrial environment

(76) Inventor: Pascal Lele, Seclin (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/996,598

(22) Filed: Nov. 26, 2004

(30) Foreign Application Priority Data
Nov. 26, 2003 (FR) 03 14097

(51) Int. Cl. G06F 7/00

(52) U.S. Cl. 707/1

(57) ABSTRACT

System for optimization of production with added value and for integration of the best business practices, which is characterized in that it includes two base modules of services application software, said first base being a central module A connected, for data extraction, with the organization information system or database for the anticipation of costs and for the control of the piloting, common to all the models, said second base being a peripheral module B of learning acceleration and to structuring of technical information actionable by the user, said second module B being an interface connected to the first module A by the connection C.

### 1—FIELD OF INVENTION

The concerned technical domain is that of the communication and information technologies (IT or CIT) whose function is to help organizations to improve their efficiency, to protect their resources, to realize costs savings and to optimize their performances.

### 2—BACKGROUND OF INVENTION

### 2.1—Introduction

CIT deal with this problem by offering solutions on five levels:
level 1, business applications: software packages/ERP, Web services, Intranets;
level 2, system networks: optimization networks, migration, OS server;
level 3, storage solutions: park management, network storage, infrastructure;
level 4, mobility and telecoms directed solutions: wireless—Wi-Fi network;
level 5: safety directed solutions: activity continuity plan, VPN, PKI.

Software packages/ERP cover all the functions of management, including henceforth marketing and decision-making, so the Customer Relationship Management (CRM), Supplier Relationship Management, Supply Chain Management, company portals and business intelligence, Product Lifecycle management, Human resource (HR), and finance.

Web services are intended for the transport, the safety and the administration.

The present invention deals with setting-up intranets of costs anticipation and performance piloting control, and leads to proactive decision-making (Proactive Performance Management).

Intranets traditionally answer to operational necessities such as collaborative work and accompaniment of the evolution of job processes in the company. The technology of proactive decision-making is an answer to the problem of return on investment. It does not enter into competition neither with the other solutions of the level 1, nor with the solutions of levels 2 to 5.

Invention deals with the problem of profitability or of return on investment (ROI) of business programs, budgets, earnings reports on projects about organizations efficiency improvement which escapes from the field of regulation of functions governed by traditional solutions.

### 2.2—Stakes and Key Concepts of the Invention

The dealt with problem is that of a technical device to build decision-making capable to ensure, on one hand, automation of transactions performance piloting control within organizations, and, on the other hand, triggering of processes of systematic socioeconomic organizations regulation. Such regulations are determined by the laws which govern motivation. The decision-making which ensue from it is dedicated to the level 3 data processing (tertiary information).

### 2.2.1—Stakes

Main stakes are: the challenge of organizations piloting in the “society of knowledge”, the construction of an organizational memory, the construction of an intelligent system or with a continuous adaptation.

### 2.2.1.1—The Challenge of Organizations Piloting in the “Society of Knowledge”

Invention joins into the context of the “society of knowledge marked, on one hand, by the fast obsolescence and the explosion of knowledge, and, on the other hand, by deep changes in the world of the work which lead to the necessity of a continuous learning. The big challenge of modern organizations piloting is to master and reduce the costs of the dysfunctions generating outlays, into real time, and also to engage their members in a step of resolution of problems, to maintain continuous learning in order not to find itself limited with respect to the direct competitors.

The present invention is based on cybernetics to build new intranet platforms able to provide the management of organizations with “intelligent systems” to adapt and to adjust their level of performance without regular intervention of external agents. These intelligent systems accelerate and increase the capacity of the individuals to learn and the capacity of the company to adapt itself to changes.

### 2.1.1.2—The Construction of an Organizational Memory

Systematic approach leads to the construction of an organizational memory requiring a wide participation of the employees and the customers, in the decision-making, the dialogue and the sharing of information. System regulates itself by regularly adjusting its indicators of technological survey. It remembers privileged “answers” (the characteristic routines of the company know-how).

### 2.1.1.3—The Construction of an Intelligent System or with Continuous Adaptation

The step of problem resolution allows integrating the learning processes of second level: “learn how to learn”. The equipped company becomes an organization where learning is done in the reflection, the action and the memorization of experiences. Norms standardized as ISO and internal control are integrated into its functioning so as to generate the specific reporting. The set of practices which characterize the learning organization is taken care of by the platform : the analysis and the anticipation of the change within the system and within its environment; the gaining and development of the abilities to question, to provoke and to modify the standards of functioning as well as their postulates; the intensification of a organisation head skilful to transform in a constant way the organization.

### 2.2.2—Key Concepts

The present invention is based on four key concepts: the control transactions of the piloting, the specialized service industry data processing, the functioning of homeostatic processes, the necessary consideration of the motivation laws by the performance management system.

### 2.2.2.1—The Control Transactions of the Piloting

What distinguishes the companies from the market is their capacity to realize internal transactions or deals for a cost smaller than the cost of the market, what allows them to exhibit a significant profit margin. The present invention starts from the principle that the system of performance piloting control is the determining element of the level of costs in an organization with regard to the costs of acceptable deals for the realization of the same deals on the market. This type of control concerns 3 factors:
the control of the capacities accounts: this type of control concerns the costs defined as fixed or not variable for a given period;
the control of the uncertainty: it does not concern here a control exercised on outside events, but a control exercised on the uncertainty of the behaviour of the persons involved in the deal, in particular in front of events which were not envisaged in their entirety during forecasts and contractual agreements;
the control of the frequency: as soon as an event occurs, a dysfunction is called to repeat (absenteeism, occupational hazards, qualitative defects, variations in materials consumption, variations in labour time, variations in rotation and training of the staff), the parties commit through activities agreements to reduce, even to avoid, the costs of these events.

Each of the functions of piloting control implies the use of CIT and engenders a cost of deal which concerns the decision and the execution. The first is the one that allows to make sure that taken decisions are correct and that they will be correctly applied; the cost of execution is, on one hand, the one that guarantees a minimum qualitative level of service or of manufactured product, and, on the other hand, the one that allows to reveal abnormalities and to handle them in real time. Procedures must indeed be implemented to identify and to correct dysfunctions, so as to allow the organization to reach the objectives in an efficient way, and so to avoid that dysfunctions and wasting leads in the more or less long term to the bankruptcy of the company.

### 2.2.2.2—The Specialized Service Industry Data Processing

CIT play a major role in the processes of auto regulation of socioeconomic systems. Four levels of information should be distinguished:
the initial or raw information corresponds to an original specialized information, without any added value;
the primary specialized information, such as scientific and technical literature, does not belong to the level of raw information because it results from a processing elaborated on behalf of the authors. But it constitutes however an initial information;
the secondary specialized information, such as databases and databanks, constitutes a richer information, because it is organized and therefore easy to handle;
the specialized service industry information corresponds to an exploitation of the secondary specialized information, such as the management application.

### 2.2.2.3—The Functioning of Homeostatic Processes

In cybernetic terms, homeostatic processes are auto regulation processes. The device of the present invention allows to pass from statics relating to the level of authority of the traditional boss, to the dynamics of balance which is based on the commitment, the grip of responsibility and the participation. Working as safety valves, the homeostatic processes allow to regulate, at the least cost, dysfunctions by generalizing a dynamics of problem resolution in real time. Everything becomes active; the organization is then capable of estimating its own progress, of controlling its functioning, of settling tensions between its members, sub-systems and other structures in the environment. The concepts of “company government” and of “internal control” aim at triggering such mechanisms.

The origin of homeostatic processes is difficult to determine. One of the most relevant hypotheses is “structuring antagonism”: during interactions, several speeches, several tendencies, divergent interests simultaneously contradict themselves, putting so the problem of their coordination in mechanisms of regulation. The construction of these mechanisms is made during the specific conflicting interactions where progress expresses itself by the elaboration in common of own centrations, coordinated in a global system capable of producing some intelligence and development.

One distinguishes two systematic types of regulation: regulation according to fixed purposes and regulation by modification of objectives. These two forms of regulation are complementary: the one determines and maintains the ideal of socioeconomic organization of shared wealth creation, whereas the other one establishes the levels of balance to be realized to aim towards this ideal. The regular functioning of the organization depends on the automatism which the processes of homeostatic regulation start with. As it is dealt with human beings' organization and not machines, auto regulation derives from the free will. This shows the importance of the motivation in the triggering of auto-regulation processes.

### 2.2.2.4—The Necessary Consideration of Motivation Laws by the Performance Management System

The device of the invention involves the registration of the collaborative interaction in precise modes of deal and motivation thresholds.

### 2.2.2.4.1—The Registration of the Collaborative Interaction Collaborative in Precise Modes of Deal

Collaborative interaction or organizational learning refers to deal processes based either on the total or limited divergence, or on the total or limited convergence.

The deal modes in case of total divergence: these are forms of influence exercised in situations where objectives appear to totally diverge about changes to be operated, and where one of the protagonists, in particular the leader, possesses more power. Imposing and conditioning are the modes of influence exercised by this type of authority. Learning methods applied in industry such as the TWI (Training Within Industry), famous in the years from 1917 to 1949, concerns imposing. Pavlovian conditioning (conditioning of type 1) and operating conditioning (conditioning of type 11) are similar modes of influence.

The deal modes in case of limited divergence: these are propaganda and manipulation. Propaganda is an information selection and deformation at the same time. Contrary to the conditioning which acts on the physiological needs of the person, propaganda acts on his/her perceptions. Manipulation is a diffuse process. On one hand, it uses reward and punishment as coercive instruments. On the other hand, it uses the reference group based on stereotypes and prejudices, as means to muddle up debate and to turn in mockery opinion considered as unacceptable.

The deal modes in case of total convergence: these are example and participation. Example supplies with a general directive in the resolution of problems. It is the mode of visuo-driving learning, which consists in showing (demonstrating) how to proceed. This deal mode improves the analysis and creation capacities thanks to the association of explanations and guided discoveries. The establishment of the best business practices raises so from the couple example—imitation. Participation is based on a democratic conception of the deal. In this perspective, learning is not considered as a knowledge acquisition process any more, but as a process of active search for solutions and for control of the application by the subject itself.

The deal modes in case of limited convergence there is limited convergence when the protagonists face a situation in which objectives essentially converge, but about which a partial discord remains. This means that long-term interests converge, but that, in the short run, the concerned persons face the problem of resources distribution.

When this scheme appears amongst actors exercising equal powers, as it is the case in the modern company, negotiation on the sharing of resources is necessary as appropriate deal mode.

### 2.2.2.4.1—The Motivation Thresholds Determinants

One distinguishes two forms of negotiation: conflicting negotiations and cooperative negotiations.

The first one is governed by a stake considered as important by the partners/opponents. This form of negotiation appears when one of two partners broke the “contract” or the status quo, action which is going to drive the partners to consider themselves as opponents. Examples are numerous: strike, lockout. . . . The importance of the stake can be concrete (economical, territorial) or symbolic (relations of power, prestige).

The second one, cooperative negotiation, is the one in which partners have a common project which they have a strong awareness of. For them, this project dominates by far the points of discord which appear therefore as secondary. Common project appears then as an over-ranked objective, a goal which can not be reached by the resources of a single individual. Negotiations which fall under this context try to determine purposes which are attractive for all. The over-ranked objective determines the management of the action. The engine of the auto-regulation processes, implying the resolution of problems in real time (the reduction of the dysfunctions generating outlays for the company), is as for it governed by the conjugation of two laws: the law on the discrimination individual/group and the law on the significant reward.

The Law on the discrimination individual/group allows to determine the most effective system of reward to activate the processes of auto-regulation in an organization. Individual reward or collective reward? Negotiation with the individuals or negotiation with the groups or unions?

Law coming from laboratory searches is the following one. In a situation deprived of any usual sign of intra-group membership and of any interaction with the outer group, the individuals always act according to their intra-group membership and to an inter-group categorization:
a) without any ambiguity, their actions tend to favor the intra-group members to the detriment of those of the outer group;
b) the individuals act in this way essentially in a situation where their individual profit is not in question;
c) the individuals do not change behaviour when they have the choice of acting according to maximum utilitarian advantages for all, combined with a maximum utilitarian advantage in favour of the members of their own group: the fact to make their own group win seems to be more important. It is here with a free discrimination which they adopt even when they are aware of the existence of the other strategies such as that of the Maximum Common Reward (MCR) and that of the Maximum Intra-group Reward (MIR). The advantages which these strategies confer are sacrificed to the desire to make ones own membership group win.

It follows that the best system of premium in an organization is the one that rewards at first the team and then the individual for its contribution to the collective result.

The law on the significant reward is the law which activates the change of attitude in the desired direction. This Law was formalized from an observation at two levels.

The first level is very old (1957). In experimental situations created for that purpose, subjects were randomly distributed on four conditions: a group received 10 $ in reward, the other one 5 $, the other one 1 $ and the other one 0.5 $. The statistical analysis of the obtained behaviour responses shows clearly that these depend on the promised reward: the bigger the reward, the less the attitude changes. The deducted law is that of the “cognitive dissonance”: if you manage to engage an individual in a counter-attitudinal behavior, you will obtain the maximum of attitude change if the necessary reward to provoke this behavior is maintained at the minimum.

The absence of a change of attitude in conditions of strong pecuniary reward explains itself by the presence of two troublemaking factors, killing the normal effect of the reward. On one hand, the promise of a reward of 10 $ becomes a troublemaking factor because it leads the subject to try to make good impression. This behavior translates the fear of a negative evaluation which becomes all the more strong as the promised reward is big. The subject of the 10$ reward is going to presume, more than the one of the 1$ reward, that the experimenter wishes to test his resistance to the lure of earning. On the other hand, reward not being given at the beginning of the experiment but only at the end, the subjects of the 10 to 5 $ rewards tend to distrust intentions of the experimenter.

One finds a similar situation in working situation. Promised premium does not lead to the expected behaviour when it is high. On the other hand, when it is low, it also leads to a behaviour of low importance: there is little to loose. It is the paradox of the profit-sharing in companies.

The law on the significant reward is more recent (1986). Significant premium is the one that rewards subject when this one freely engaged himself/herself in a process of change. It is generated by the subject itself in a situation of resolution of problem when the subject has been involved in the diagnosis and knows the totality of generated earnings which the premium comes from. In this situation, distribution rules are negotiated and known, as well as evaluation criteria of the result and of the premium calculation. In organizations governed by the employment contract paid on the budget or the sales turnover, only the recoverable potential on the dysfunction costs and wastings undergone by the company, offers the perfect conditions of triggering of the auto-regulation processes resulting from the maximum commitment of every staff member efforts to the resolution of problems in real time.

### 2.3—State of the Art Dealing with the Problem

The offer of technologies of performance optimization is currently reduced to the treatment of the integration problem of applications: languages integration, alternative ERP (Enterprise Resource Planning), EAI (Enterprise Application Integration), convergence of internet, intranet and extranet platforms.

### 2.3.1—Languages Integration: the XML Revolution

The first solution for costs reduction was the setting up of a common language in 1996: the extensible Markup Language. The XML created a common universe for data exchange between applications, facilitating therefore these exchanges, while freeing, or almost freeing, itself from constraints related to the language. This universality opened a sphere of action at two levels.

The first intervention field of the XML concerns the deployment of inexpensive, reliable and successful enterprise applications, which are based on internet technologies.

The second XML field radically transforms the nature of the Web and of the electronic exchanges on internet. It has an important impact on the business, which requires the exchange of documents as the order forms, the invoices, the receipts, etc. All software packages publishers have adopted it, forming a universal base for the exchange of inter—applicative information. The XML engenders a decrease of costs related to the reduction of human intervention and of investments in the information system.

### 2.3.2—The Alternative of ERP II and EAI

For the reduction of the infrastructure costs, software industry proposes either a migration of the ERP of first generation towards the ERP of second generation (ERP II), or the implementation of an EAI platform. The service oriented architecture of the ERP II, and the EAI platforms, contribute to soften the information system of big companies as for small and medium-sized firms, and facilitate the integration of heterogeneous applications to reduce the costs of scale. EAI platforms editors and ERP II editors fight against each other to take a lead on this market of the processes orchestration. The ROI (return on investment) problem remains however entirely unsolved, for the redemption of CIT costs as for the global profitability of the organization, which applications have for objective to make more reactive, more effective, so more efficient.

### 2.3.3—The Convergence Internet, Intranet and Extranet

Since the creation of the first intranets, at the beginning of the 90s, followed by extranets, most of the companies have spread various platforms (teams, concepts, applications and contents on their Web sites). As the majority of these sites uses the same IP technology, requires similar, even identical, infrastructures and software packages, and supplies the same type of information to the various groups of users, it seemed to be obvious that regrouping and rationalizing these resources would allow to realize scale savings. So, a consensus appeared on the necessity to have the intranet, extranet and internet platforms converging for a better integration of e-business technologies, a better information traffic and an increased productivity. But one quickly noticed that what one could win in costs, would lead to taking big risks in terms of security and business intelligence.

So the followers of the intranet, extranet and internet platforms convergence are now more and more rare. Major tendency considers first of all that a site has to help users and facilitate their various tasks iin view of the common objective of value creation. It means that optimal concept differs according to the type of user and its needs. It means then that the “look” of Intranets must be different from the one of public Web sites. The employees must know at once when they have access to internal and confidential information, and when they have access to information which they can freely share with persons not belonging to the company.

### 3—SUMMARY OF THE INVENTION

The technical solution brought by the invention to solve the above mentioned porblems consists in building and articulating in the general databases or the secondary specialized information (database or datawarehouse), a extraction, analysis and processing system for specialized service industries data which are necessary for the prevention and the reduction of dysfunctions costs. The invention is governed by three types of measures: taking into consideration of the accounting principles of the ROI, the implication of the customer in the procedure of resolution of the problem, integration of the Best Business Practices and Better Professional Practices (BBP & BPP). The invention creates a costs savings and inheritance protection oriented proactive decision-making tool, in opposition to a traditional predictive decision-making tool.

### 3.1—Taking into Consideration of the Accounting Principles of the ROI

There are generally three approaches to determine return on investment of an infrastructure.
a) Attributing a value to the infrastructure: 1 dollar invested equal 1 dollar won in return.
b) Attributing a non-trade value to the infrastructure.
c) Quantifying and estimating specific profits which the infrastructure could generate.

Considering displayed ambitions, the offer in CIT solutions cannot be limited to these three big approaches. Most of the company or organization leaders indeed need more precise objectives and business plans when it is a question of improving efficiency and performance.

The new platform of the invention allows to remedy this inconvenience. It contains, according to a first characteristic, a proactive system, which acts as a railing, and which guarantees, on the internal level, that the calculated profitability and added value objectives are reached, as well as the self-financing of the projects of performance improvement. The new platform of the invention is based indeed on the accounting principle according to which the organization is profitable only if it succeed in covering its capacity costs with a significant margin on variable costs. Any action, any CIT offer which increases margin on variable costs, increases the profit of an equal amount, if the costs of capacity are not modified by this action.

As the margin on variable costs depends on factors of costs weighing down (cost inductors or cost driving), implanting of CIT solutions aiming at the performance improvement has a limited optimizing effect, which can even be null or negative if breaches are not sealed, if dysfunctions and wasting costs in term of manpower and materials consumption are not diagnosed, calculated and mastered in real production time, in order to guarantee that the objectives are reached and that the value is created. The new platform of the invention puts the traditional calculation of variations in a particularly dynamical management procedure: in order to be controllable, a variation must be reducible and the means of this reduction has to be in the hand of the co-worker responsible for the variation. Creation of value must be therefore initialized first and foremost in professional processes.

### 3.2—The Implication of the Customer in the Procedure of Resolution of the Problem

The Invention opens to the customer a perspective which increases its power of control on the product: the automated total co-management. The step of resolution of problem is generally a process in four stages.

First comes the definition of the problem a problem begins with an illness, or a dysfunction.

Then comes the inventory of solutions it is a creative stage par excellence because it is a question of finding the device which would give the largest possible satisfaction, that is the one which solves the diagnosed problem.

Third comes the choice of the solution or the classification of solutions: the evaluation of a good solution goes with the evaluation of what it brings, in particular in term of return on investment (ROI).

Finally, fourth comes the business planning of the implanting of the solution: the same criteria of evaluation are applied and are connected to the return on investment. The business planning of the implanting of the solution is an operation which purpose is to order among them and to arrange the time all the material, financial and human elements (so the implied actors and the intensification of their motivation), in order that their logical sequence corresponds to fixed ROI objectives and in order that they are practicable.

Every applications publisher implicitly or explicitly subscribes to a theory of implanting solution, which can be:
either, broadcasting, as done by advertisers: it persuades the customer to use a solution rather than another one. In that case, the customer does not exercise any control on the choice of the product, but he can control implanting by imposing a rhythm on it;
or, co-economic planning: the addressee of the solution exercises a direct control, only on the business planning of the implanting;
or, consultation the addressee collaborates with the publisher on the first two stages of the process;
or, co-management: the customer controls with the publisher of the solution all the stages of the process of managing the problem. The realization at every stage is a collaboration work.

### 3.3—Creation of the Proactive Decision-Making System

The invention creates a model of intranet relying on the joining of two bases of services directed to the co-management of the procedures of resolution of problem: a base “A” of anticipation and piloting of the performance, and a peripheral base “B” of integration of learning and best business practices. This represents the system of orchestration of the organizational learning of which function is to collect, by way of an Web interface accessible to the entire staff, practical information that accelerates learning, codification of professional practices and integration of best business practices.

### 3.3.1—The Pedestal “A” of Anticipation and Piloting of the Performance

Traditional decision-making in management of the performance relies on random statistics based predictive analysis. This model contains in that sense a too important error margin and risk-taking amount, for forecasts of result on which the leaders of company engage their responsibility vis-à-vis their partners and the financial market.

The problem of the economic organizations is that of the reliability of forecasts. Warning is of the order of the forecast, of indications given on the likely state of results over the period to come (receipts and expenditure forecasts in the establishment of a budget). To foresee is to imagine in advance a future event as likely, to organize beforehand, to decide for the future. One knows this, forecast is all the more reliable as it is based on the evaluation—diagnosis and on the control of dysfunctions in real time.

Systems of projected analysis based on the probability or statistics are of the order of the prophecy. Control of dysfunctions is of the order of the prevention. This latter consists in going beyond the need, beyond the result foreseen to better satisfy it. Prevention is of the order of anticipation. To anticipate (anti=ante=before) mean executing before the determined time. Anticipation is what is done before the expected date or without waiting for the event. It is the movement of the thought which imagines or lives beforehand an event. Now, one does not know how to translate into statistics the a priori and so its probability. That is why one always supposes that it is either neglictible or that it forces application enough so that all the possible interpretations are of the same category. The invention allows to reach a higher level of exactness in business forecasts by constituting the system of measurement into which the results of calculations or instruments and indicators reading translate, for the addressee of the platform, the real quantities which are the object of these calculations or this reading and are exempt from errors, following the example of the “margin of statistical error”.

The errors of the traditional systems which are now mastered by the invention are numerous:
Random errors: unpredictable errors in estimation. These errors tend to cancel itself in a large sample, contrary to the systematic errors which go all to the same direction.
Sampling errors: errors which occur when data are collected on a part only of the population. They are usually measurable through the data of the sample in case of probabilist sampling.
Errors of non-answer: errors caused by the absence of interview or non-answer to a question in a questionnaire.
Errors of answer: differences between true answers to questions and answers given by the persons; the errors can be attributed to the persons, to the interviewers, to the questionnaires, to the processes of inquiry or to the interactions between the persons and the interviewers.
Processing errors: errors which inserts into an exercise of transformation of the data of questionnaire, check lists, etc., in sets of additions and estimations.
Estimation errors: come from drawing to large conclusions based on a sample, in view of predicting certain characteristics or tendencies on the whole of the population.
Median errors: random values of the central elements when data are ordered from the lowest to the highest; measures of the central tendency.

The new platform of the invention has for aim to be used as a structural base to a decision-making portal totally subjected to the decision power of the customer whom it supplies the solutions for anticipation to. Intranets are generally used for four types of applications:
communication and collaboration: to send and receive E-mail e.g.
Web publishing: to develop and publish documents.
Business and operations management: management information systems, access to databases . . .
Intranet portal management: administration of all the network functions, including the servers, the customers, the security . . .

The new platform of the invention is designed as a support for bridges between operational and decision-making systems, in particular the Management Information Systems (MIS). The function of the traditional MIS is to inform the managers so that they decide, and their hierarchy so that it knows where they are on the matter. The traditional MIS offer only two possibilities:
Hierarchy is alerted at the same time as the manager in charge of the process to be managed. These systems are thus fewly decentralized
Hierarchy is informed later. These are thus post-evaluation systems or reporting system.

The traditional MIS is thus characterized either by decentralization to some individuals, or by post-evaluation information fortification.

The new platform of the invention supplies the structural bases to spread the decision-making information system to the entire staff in the organization. It decentralizes the preoccupations of costs at all hierarchical levels to strengthen the grip of responsibility and the participation of all in the creation of value. The most recent experiences demonstrate a very clear need for the equipment of a wider proportion of the actors of the company, even to all these actors. Until then reserved for the managers or decision-makers in the company, decision-making solutions target, indeed, more and more clearly the operational.

The Invention exceeds the traditional level of simple deployment of applications intended for numerous users and which is currently the major criterion of measure of the performance of the CIT to constitute a platform of orchestration of the organizational learning.

### 3.3.2—The Base “B” of Orchestration of the Organizational Learning

Professional practices are processes of acquisition, broadcasting and production of knowledges and competence in an organization. Initially, the question of learning was treated only on the point of view of the direct performance of the work. Progressively, learning became an organizational fact: it is determined with the rules of the organization, the routines; it takes part in the modification of the organization. Organizational learning is based on the learning of individual members but does not limit itself to the sum of individual learning. It starts from the principle that working activity generates localized learning; that these localized learning produces adaptive and innovative, tacit or explicit, analytical or empirical, know-how, anchored in a commercial economic reality.

The members of the organization contribute to the organizational learning by the production of a “capacity of localized expertise”. The new plafformof the invention articulates the device around the concepts of:
Project group: coordinates launching at the builder level.
Starting up group: pilots launching at the factory level.
Hard core: allows the participation of the manufacturing operators and the maintenance operators.
Human management of the learning process: selection, recruitment of the teams, trainings, evaluation.
Putting the human management in coherence with the technical management: administering the constraints of the rise in production, ensuring the continuity in implication and motivation of the operators, to ensuring preservation and development of performances.

Organizational learning is not separable from action. Organizational learning is potentially carried by the whole of the members of the organization. Organizational learning is not necessarily deliberate. Organizational learning is not necessarily effective. After all, organizational learning is structuring, as are homeostatic mechanisms.

The stake of proactive decision-making is not so much to equip, through the intranet/extranet technology, traditional decision-maker but to be of use to the actors on the field, until then forgotten by decision-making systems and which however carry action and determine added value in everyday life. The new platform of the invention is thus a support for bridges between operational and decision-making systems. As a consequence, it allows CIT to really contribute to the improvement of the efficiency of organizations, by bringing a coherence, from start to finish, in the chain of the decision up to the action, with consideration of costs, added value, evolution of knowledge and learning at all levels of the organization. Constituents widely supported by the information system are:
analysis, integrating the processes of anticipation, is dealt with by the modules of help in decision-making;
The realization of actions is directly translated in the operating modules, whereas sharing and enrichment lean on the knowledge databases and the best business practices integration tools. In that sense, the new platform of the invention allows to make from every actor of the company a informed decision-maker. The device of the invention therefore takes up the challenge of the decision-making data processing for all. It settles the problems of enterprise reporting (Information Delivery), and of integration with services collaborating in the operation, in the internal control and in the social preservation of the inheritance.

The system of the invention is thus a system for optimization of production with added value and for integration of the best business practices characterized in that it includes two base modules of services application software, said first base being a central module (A) connected, for data extraction, with the organization information system or database for the anticipation of costs and for the control of the piloting, common to all the models, said second base being a peripheral module (B) of learning acceleration and to structuring of technical information actionable by the user, said second module (B) being an interface connected to the first module (A) by the connection (C).

Preferably, the first module (A) includes a module (1) of diagnosis of mobilizable potential financial resources, and benchmarking indicators calculation, a module (2) of strategic business planning, of organization and intensification of the participation by thresholds of motivation, a module (3) of evaluation of the accounting performance, and financial reporting, a module (4) of control of the operational piloting based on a structure of additive universal indicators, a module (5) of evaluation and reporting of the quality performance for the industrial sector and services, a module (6) of evaluation and reporting of the quality performance for the health sector.

Preferably, the second module (B) includes a module (7) of measure of the optimization of the financial management, a module (8) of optimization of the sale/marketing management, a module (9) of optimization of the management of operations, a module (10) of optimization of the knowledge and learning management, and a module (11) of optimization of the strategic position.

Preferably, the connection (C) includes said module (4) of control of the operational piloting based on a structure of additive universal indicators, in order to establish a module of orchestration of the piloting and the resolution of problems, organizational learning, adaptation to all the markets and continuous improvement.

Preferably, an organization information system or datastore or database (12) is connected to the platform by way of data extraction which can be activated by said module (1) of diagnosis of the potential, and by said module (4) of control of the operational piloting based on a structure of additive universal indicators, with synthesis of the periodic performances transfered on one side to said module (3) of evaluation of the accounting performance, and financial reporting, which strengthens and establishes the reporting of economic and accounting data, and on the other hand to said module (1) of diagnosis of mobilizable potential financial resources, and benchmarking indicators calculation, which updates potential and indicators of programming of the objectives of performance to come, said module (4) of control of the operational piloting based on a structure of additive universal indicators, leading to the transfer of the data of management of the quality in said specialized module (5) of evaluation and reporting of the quality performance for the industrial sector and services, or in said specialized module (6) of evaluation and reporting of the quality performance for the health sector, said modules establishing reporting intended for the bodies of accreditation on quality, being directed to the exit of said system and being part of the extranet interface.

### 4—DRAWING

FIG. 1 gives a functional overview of an architecture of the system of the invention

### 5—DETAILED DESCRIPTION

### 5.1—Structure of Functioning

The structure of functioning is articulated on two systems: a central system as a base, business workflow analysis, for the expert analysis of anticipation, calculation and control of the piloting of the production with added value and a peripheral system, Web interface for facilitation of learning and for integration of best business practices.

The central system as a base for the analysis of anticipation and control of the piloting of the production with added value includes:
a function of diagnosis of mobilizable potential financial resources;
a function of calculation of the indicators of benchmarking and of control of the piloting;
a function of strategic business planning, organization and control of the operational piloting;
a function of organization of the participation by motivation thresholds;
a function of evaluation and reporting of the accounting and financial performance;
a function of evaluation and reporting of the performance in term of quality.

The peripheral system, Web interface for acceleration of learning and for integration of best business practices includes:
a function of optimization of the financial management;
a function of optimization of the sale/marketing management;
a function of optimization of the operations management;
a function of optimization of knowledge and learning management;
a function of strategic position management.

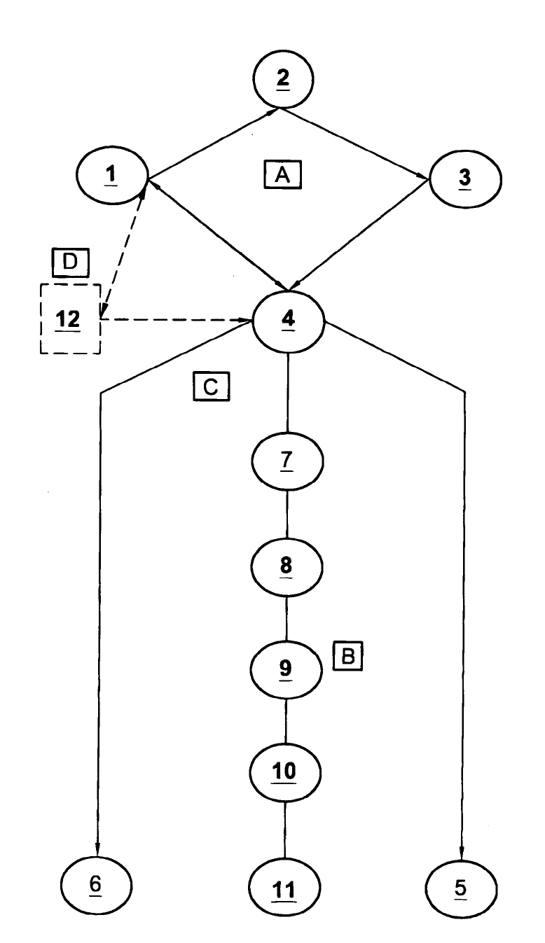

FIG. 1 illustrates an architecture of the system of the invention. In reference to this figure, the system contains two articulated bases.

### 5.1.1—The First Base A

It constitutes the basic system and includes
a module 1 of potential diagnosis and of piloting indicators calculation,
a module 2 of strategic business planning and of responsibility centers and motivation organization,
a module 4 of operations piloting,
a module 3 of accounting evaluation and reporting,
a module 5 of quality evaluation and reporting of the industry and services sector, and
a module 6 of quality evaluation and reporting of the health sector.

The system also includes:
a module of measure of the interval of tolerance of dysfunctions which can itself includes tables of calculation of the average and standard deviation of the variable costs of income statement.
a module of analysis and dysfunctions indicators quantification data collection which can itself includes automated forms for identification of the variable costs inductors of accounts of loads, and automated forms for identification of the variable costs inductors of accounts of products;
a module of calculation of the indicators of value piloting and of the strategic monitoring which can itself includes tables of calculation of the margin on variable costs and of added economic value, tables of calculation of added value on human resources through the learning phenomenon, and tables of calculation of the hourly contribution to the margin on variable costs.
an engine of financial interpretation and quantification, which concerns the automated processing of additive data of universal inductors of basic dysfunctions costs in organizations: absenteeism, industrial hazards, qualitative defects, deviation on direct productivity (manpower time and materials consumptions), and deviation on staff rotation training.

The result generated by this engine is presented on a table of synthesis dealing with the current value of the piloting indicators of the company.

The module 2 of strategic business planning and organization includes:
a matrix of the multi-annual business planning keys of standard and operational objectives of sales, variable costs, budgeted margin, supplies of raw materials, supplies in details, reduction of expected variable costs, use of the manpower, investments, overheads, current result, operational profit, distributed added value;
a table of the priority action plan of responsibility centres;
a matrix of the thresholds of motivation and added value distributed in premiums and intensification of self-financing capacity,
a matrix of translation of strategic objectives at the level of the staff members, and of the evaluation of the contribution of each to the collective result.

The module 3 of accounting performance evaluation and reporting includes:
a module of intermediate data processing;
a table of synthesis of the contributions of the responsibility centres and of individuals in the collective result;
a table of synthesis of the data of evaluation of accounting performances through costs indicators of;
a table for the periodic balance or assessment by costs components;
an input and calculation form of the variable costs deviation
matrix of keys of distribution of the distributed added value (DAV) over the period;
key form for evaluation of individual performances and for transfer of the premium to the salary.

The module of annual data processing and of consolidation of the projected budget, synthetic earnings report, includes the traditional calculation of deviations, but with this difference that it integrates the earnings report of next year or year N+1 based on the indicator of human resources added value.

The traditional tables of the accounts of the results which are so modified are the following ones:
table of analysis and programming of indicators and ratios of performance piloting,
table of analysis and programming of the earnings reports of synthesis,
table of analysis and programming of the ratios of structures,
table of analysis and programming of the self-financing capacity,
table of analysis and programming of breakeven points,
table of analysis and programming of the synthetic balance,
table of analysis and programming of the detailed balance,
table of analysis and programming of the financing statement,
table of analysis and programming of the operation cycles,
table of analysis and programming of the synthetic finance,
table of analysis and programming of the investments,
table of analysis and programming of the redeems,
table of analysis and programming of the trade activities,
table of analysis and programming of the production activities,
table of analysis and programming of the external loads,
table of analysis and programming of taxes,
table of analysis and programming of staff and other loads,
table of analysis and programming of the detailed finance.

The module 5 of quality evaluation and reporting of the industry and services sector includes:
a form for quality management data extraction,
a form for translation of the quality management methodology,
a table of the reference frame for the customer rights and information,
a table of the reference frame for establishment and sectors management,
a table of the reference frame for human resources management,
a table of the reference frame for logistic functions management,
a table of the reference frame for information system management,
a table of the reference frame for quality and risks prevention management,
a table of the reference frame for infectious risk surveillance, prevention and control.

The module 6 of quality evaluation and reporting of the health sector includes:
a technical automated form for the methodology of quality management,
an automated form for extraction of the data of quality performances of the management information system,
a table of the reference frame for the patient rights and information,
a table of the reference frame for patient file,
a table of the reference frame for the organization of caring of the patient,
a table of the reference frame for establishment and sectors management,
a table of the reference frame for human resources management,
a table of the reference frame for logistic functions management,
a table of the reference frame for information system management,
a table of the reference frame for quality and risks prevention management,
a table of the reference frame for infectious risk surveillance, prevention and control.

The module 4 of operations piloting serves as a connection C between base A and base B. It includes form for recording of performances data and for the system of automatic extraction of the management information system or company database data:
forms for absenteeism costs data collection and processing (analysis and quantification grids, dashboard of recording of weekly data; dashboard of monthly synthesis),
forms for occupational hazards costs data collection and processing (analysis and quantification grids, dashboard of recording of weekly data, dashboard of monthly synthesis),
forms for qualitative defect costs data collection and processing (analysis and quantification grids, dashboard of recording of weekly data, dashboard of monthly synthesis),
forms for direct productivity deviation data collection and processing (time of manpower and materials consumptions),
forms for staff rotation and training deviation costs data collection and processing (analysis and quantification grids, dashboard of recording of weekly data, dashboard of monthly synthesis).

### 5.1.2—The Second Base B

It constitutes a peripheral system, Web interface of acceleration of learning and integration of the best business practices. It includes:
a module 7 of optimization of the financial management,
a module 8 of optimization of the sale/marketing management,
a module 9 of optimization of the operations management,
a module 10 of optimization of knowledge and learning management, and
a module 11 of optimization of the strategic position.

The module 7 of optimization of the financial management includes:
a sub-module of accounting by activity (Activity Based Costing or ABC);
a sub-module of costs of returns and of sale decision-taking
a sub-module of analysis of financial status by ratios;
a sub-module of management accounting
an internal control mechanism
a sub-module of elaboration of the chart of accounts of company and financial status;
a sub-module of control of the export sale (price, management and strategies);
a sub-module of manufacturer selling price calculation for sell to large distributors;
a sub-module of purchases and accounts to be paid
a sub-module of customer accounts.

The module 8 of optimization of the sale/marketing management includes:
a sub-module of purchases and accounts to be paid
a sub-module of comparative analysis of the value of products by type of customer;
a sub-module of elaboration of an agreement with retail distributor;
a sub-module of elaboration of an agreement with an industrial agent;
a sub-module of elaboration of an agreement with a distributor;
a sub-module of elaboration of conditions schedule;
a sub-module for making successful the recruitment of a sales director;
a sub-module of sales management;
a sub-module of elaboration of a improvement plan of the marketing function;
a sub-module of elaboration of a commercial proposition to large distributors;
a sub-module of selection of an agent, a distributor or a retail dealer;
a sub-module of electronic data exchange for networking and selling to large distributors;
a sub-module of elaboration of a communication plan to improve sales.

The module 9 of optimization of the operations management includes:
a sub-module of stock management;
a sub-module for succeeding in environmental management of company;
a sub-module to implant a just in time system.

The module 10 of optimization of knowledge and learning management includes:
a sub-module of elaboration of a frame reference for competence with connections by professions, posts and plans of evolution of the staff;
a sub-module of identification of the individual and collective training needs;
A sub-module of elaboration of a multi-annual training plan
A sub-module of definition of competence and levels of competence per post and of integration of these data into annual forecasts;
A sub-module of estimation of the degree of versatility of the staff;
A sub-module of learning management per project, order and objective;
A sub-module of integration of human resources in the strategic potential of the organization.

The module 11 of optimization of the strategic position includes:
A sub-module of evaluation of the factors of competitiveness;
A sub-module of evaluation of external strategic positions;
A sub-module of evaluation of internal strategic positions as competitive advantages, financial forces;
A sub-module of calculation of the strategic positioning.
A sub-module of codification of professional practices.

### 5.2—The Thematic of Realization

The thematic of realization covers software engineering and intranet architecture.

### 5.2.1—Software Engineering, Source Code Specification and Production

The tools and methods which are use here for includes:
specification of common features in software packages, of which the formalisms of specification (UML);
design of software: design tools, software engineering, development environment;
automatic generation of code according to a formal specification;
design patterns;
automation of code optimization;
formal description of the code, grammars of manipulated languages.

These fields are, for example: compilation, interpretation of code, translation of code in a programming language towards another one.

### 5.2.2—The Intranet Architecture

Generally, an intranet has an client/server architecture n-tiers which is based on all or part of the following components:
file server, NAS, SAN (for data sharing);
http servers of the intranet (similar to Web servers)
database server (for the information storage);
mail server (for electronic exchange of mails or instant messaging);
authentication server (for users identification and address book storage);
client servers and software for network/systems supervision (the protocol SNMP is generally used to get information about the status of the various components of the network)
visio-conference servers;
switches, routers, firewalls (elements of infrastructure).

The platform is connected to the Internet network by way of one or several gateway and one or several firewalls which isolate it from sensitive areas from the security point of view thanks to a “demilitarized zone” or DMZ. The accessible network part from Internet is the extranet.

Features offered to the users are gathered by way of a Web interface (with display in a web navigator). The storage of data shared on the intranet is made in a privileged way on a NAS (Network Area Storage) or on a SAN (Storage Area network) which will form a dedicated part of the internal network.

### 5.3—The Industrial Applications of the Invention

The invention is particularly intended to the organization and animation of the poles of competitiveness, for the fast adaptation to the markets onto which one wants to intervene, in the integration of the best business practices to succeed on these markets, in the modernization of organizations and in the change driving and management. Two axes of industrial applications are mainly offered: the optimization of the performance and the automation of the learning company.

While the invention has been described with reference to a preferred embodiment, various changes and modifications could be made therein by one skilled in the art without departing from the scope and spirit of the invention as defined by the appended claims.

Without further elaboration, it is believed that one skilled in the art can, using the preceding description, utilize the present invention to its fullest extent. The alone preferred specific embodiments are, therefore, to be construed as merely illustrative, and not limitative of the remainder of the disclosure in any way whatsoever.

The entire disclosure of all applications, patents and publications, cited herein and of corresponding French application No. 0314097, filed Nov. 26, 2003 is incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. System for optimization of production with added value and for integration of the best business practices characterized in that it includes two base modules of services application software, said first base being a central module (A) connected, for data extraction, with the organization information system or database for the anticipation of costs and for the control of the piloting, common to all the models, said second base being a peripheral module (B) of learning acceleration and to structuring of technical information actionable by the user, said second module (B) being an interface connected to the first module (A) by the connection (C).

2. System according to claim 1, characterized in that said first module (A) includes a module (1) of diagnosis of mobilizable potential financial resources, and benchmarking indicators calculation, a module (2) of strategic business planning, of organization and intensification of the participation by thresholds of motivation, a module (3) of evaluation of the accounting performance, and financial reporting, a module (4) of control of the operational piloting based on a structure of additive universal indicators, a module (5) of evaluation and reporting of the quality performance for the industrial sector and services, a module (6) of evaluation and reporting of the quality performance for the health sector.

3. System according to claim 1 characterized in that said second module (B) includes a module (7) of measure of the optimization of the financial management, a module (8) of optimization of the sale/marketing management, a module (9) of optimization of the management of operations, a module (10) of optimization of the knowledge and learning management, and a module (11) of optimization of the strategic position.

4. System according to claim 1 characterized in that said connection (C) includes said module (4) of control of the operational piloting based on a structure of additive universal indicators, in order to establish a module of orchestration of the piloting and the resolution of problems, organizational learning, adaptation to all the markets and continuous improvement.

5. System according to claim 1 characterized in that an organization information system or datastore or database (12) is connected to the platform by way of data extraction which can be activated by said module (1) of diagnosis of the potential, and by said module (4) of control of the operational piloting based on a structure of additive universal indicators, with synthesis of the periodic performances transfered on one side to said module (3) of evaluation of the accounting performance, and financial reporting, which strengthens and establishes the reporting of economic and accounting data, and on the other hand to said module (1) of diagnosis of mobilizable potential financial resources, and benchmarking indicators calculation, which updates potential and indicators of programming of the objectives of performance to come, said module (4) of control of the operational piloting based on a structure of additive universal indicators, leading to the transfer of the data of management of the quality in said specialized module (5) of evaluation and reporting of the quality performance for the industrial sector and services, or in said specialized module (6) of evaluation and reporting of the quality performance for the health sector, said modules establishing reporting intended for the bodies of accreditation on quality, being directed to the exit of said system and being part of the extranet interface.
